(19) United States
(12) Patent Application Publication
(10) Pub. No.: US 2018/0150856 A1
(43) Pub. Date: May 31, 2018

(54) LONG TERM PREDICTION SYSTEM

(71) Applicant: Facebook, Inc., Menlo Park, CA (US)

(72) Inventors: Zhengyong Zhu, San Jose, CA (US); Jiajin Yu, Fremont, CA (US); Kevin Wenkai Heh, San Jose, CA (US)

(21) Appl. No.: 15/365,625

(22) Filed: Nov. 30, 2016

(51) Int. Cl. G06Q 30/02

(52) U.S. Cl. CPC G06Q 30/0204

(57) ABSTRACT

An online system provides a third party system with the trend in the total monetary value over time for groups of users that meet specific targeting criteria provided by a third party system. The target groups of online system users are divided further into segments according to demographics within the group and their respective base values are observed over an observation time period. Trend values for each segment are formulated based on changes in the respective base values over time. These trend values are weighed according to the number of online system users comprising each segment. More users in a segment results in a larger weight placed on the trend value associated with that segment; fewer users results in a smaller weight. The final value associated with the entire target group of users derives from combining the trend values for each segment within the target group.

### BACKGROUND

### 1. Field of Art

This disclosure relates generally to capturing price trends of online system users throughout the year, and particularly to predicting total values for groups of online system users over periods of time.

### 2. Description of the Related Art

An online system allows its users to connect to and communicate with other online system users. For example, an online system allows a user to interact with sponsored content and assigns a value corresponding to the degree to which the user engages the sponsored content. An online system may establish values for other users, where the values can represent engagement from the other users with content items provided by a third party system.

However, existing solutions merely present to a third party system the most current values assigned to online system users and do not account for changes in value over time. As a result, when the online system reports values of its users to third party systems for the purpose of estimating a value associated with sponsored content, it may be incapable of projecting what the value might be within a future time period. This means that estimating future value results in an approximation might significantly deviate from the actual value of online system users and target groups.

### SUMMARY

An online system provides third party systems with the total value associated with a group of online system users, where the total value is derived from differences in trends over time. The value provides information to the third party system on the trend in the price for presenting content to these users over time, as the price for users may increase as their value goes up, and value may change across time periods or seasonally (a user's value may increase over Black Friday or other holidays). The online system segments a group of users before predicting a trend in value for these users. A group of users matching a third party system's targeting criteria for a content item is selected. The third party system also defines a timeframe. The users are segmented according to quantifiably similar characteristics (e.g., age range, gender, interests, other demographics, etc.). For each segment, the system computes a trend value for the segment over the time specified by the third party system. This trend value may determine the trend in fluctuations corresponding with a user's base value based on time (e.g., different periods over a year). For example, users in a particular demographic segment may have a higher value (and thus a third party system has to be a higher price to present content to them) at different times relative to their typical value. The online system modifies this base value for that segment according to the trend value. The trend values for each segment are weighed in accordance with the number of users within each respective segment, and the weighed values are combined into a final value amount according to the weights. This final value amount may be used to predict a total value for the entire group at whatever time period the third party system has specified for the campaign; this captures differences in trends for user values throughout the a specified period of time, thus allowing third party systems to plan ahead with regard to content campaigns and expected pricing, and they can use this information in budgeting.

### BRIEF DESCRIPTION OF DRAWINGS

FIG. 1 is a block diagram of a system environment for predicting a total value for groups of online system users according to one embodiment.

FIG. 2 is a block diagram of an online system for capturing differences in trends of online system users over time according to one embodiment.

FIG. 3 is a block diagram of a segment trend predictor according to one embodiment.

FIG. 4 is a graph illustrating trend value prediction according to one embodiment.

FIG. 5 is a dataflow diagram that depicts the process of determining total value for a group of online system users according to one embodiment.

FIG. 6 is a flow chart illustrating the process for translating targeting criteria into total group value according to one embodiment.

The figures depict embodiments of the present disclosure for purposes of illustration only. One skilled in the art will readily recognize from the following discussion that alternative embodiments of the structures and methods illustrated herein may be employed without departing from the principles of the disclosure described herein.

### DETAILED DESCRIPTION

### I. System Overview

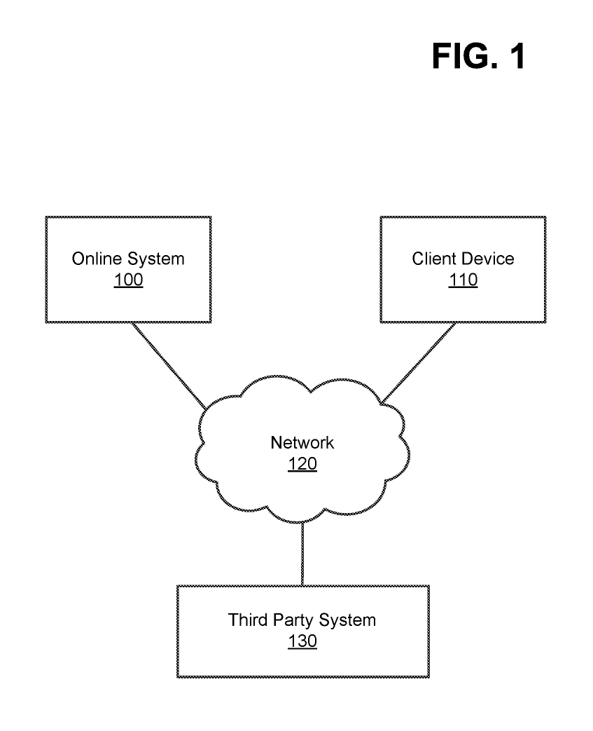

FIG. 1 is a block diagram of a system environment for predicting a total value for groups of online system users according to one embodiment. The system environment includes an online system 100 (e.g., a social networking system), a client device 110, a network 120, and a third party system 130 specifying targeting criteria and a timeframe. In other embodiments, different and/or additional entities can be included in the system environment.

The client device 110 is a computing device capable of receiving user input as well as transmitting and/or receiving data via the network 120. In one embodiment, a client device 110 is a conventional computer system, such as a desktop or laptop computer. Alternatively, a client device 110 may be a device having computer functionality, such as a personal digital assistant (PDA), a mobile telephone, a smartphone or another suitable device. A client device 110 is configured to communicate via the network 120. In one embodiment, a client device 110 executes an application allowing a user of the client device 110 to interact with the online system 100. For example, a client device 110 executes a browser application to enable interaction between the client device 110 and the online system 100 via the network 120. In another embodiment, a client device 110 interacts with the online system 100 through an application programming interface (API) running on a native operating system of the client device 110, such as IOS® or ANDROID™.

The network 120 includes any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third party systems 130 may be coupled to the network 120 for communicating with the online system 100. In one embodiment, a third party system 130 is an application provider communicating information describing applications for execution by a client device 110 or communicating data to client devices 110 for use by an application executing on the client device 110. In other embodiments, a third party system 130 provides content or other information for presentation via a client device 110. A third party system 130 may also communicate information to the online system 100, such as sponsored content or information about an application provided by the third party system 130.

In some embodiments, a third party system 130 generates a group of users, and may obtain information from the online system 100 maintained for the group of users. For example, the third party system 130 generates a group by specifying user identifying information, such as electronic mail (“email”) addresses, of users in the group to obtain information associated with users of the group maintained by the online system 100. As an example, the third party system 130 generates a group including email addresses of users who accessed a particular web page or who downloaded a particular application provided by the third party system 130. FIG. 1 illustrates an embodiment of the third party system 130 in which targeting criteria are provided to the online system 100 to generate a group of users of the online system 100 to receive sponsored content within a specific timeframe.

The online system 100, in one embodiment, determines trend values for groups of users. These base values may in some cases be related to compensation received by the online system 100. In determining these base values, the online system 100 may receive targeting criteria from the third party system 130. Targeting criteria provided by the third party system 130 specify one or more characteristics of online system 100 users eligible to be presented with sponsored content. For example, targeting criteria are used to identify online system 100 users having user profile information, edges, or actions satisfying at least one of the targeting criteria. Hence, targeting criteria allow the third party system 130 to identify online system 100 users having specific characteristics, simplifying subsequent distribution of sponsored content to different users.

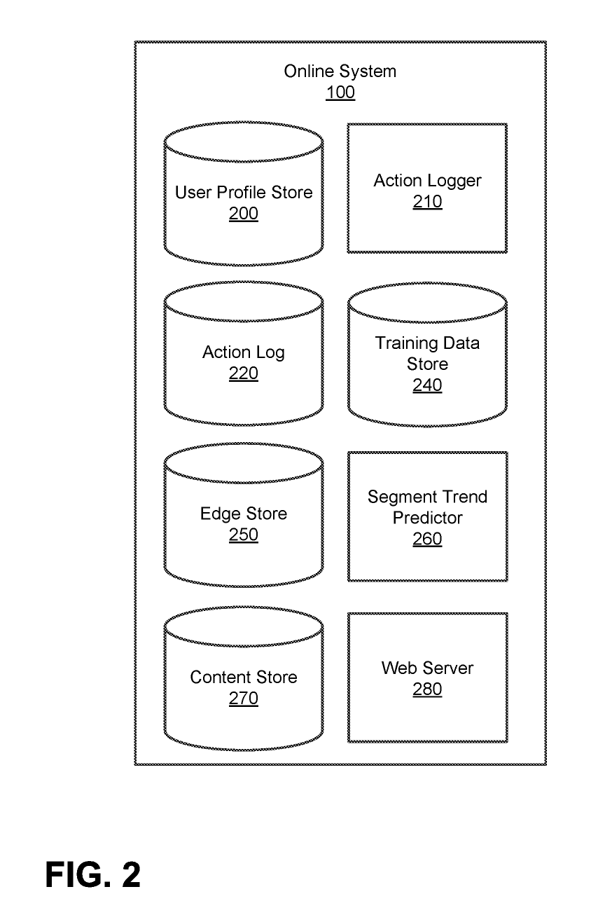

In one embodiment, targeting criteria may specify actions or types of connections among online system 100 users or objects within the online system 100. Targeting criteria may also specify interactions between a user and objects performed external to the online system 100, such as on the third party system 130. Including specifications of interactions in targeting criteria allows third party systems 130 to further refine online system 100 users, including groups of online system 100 users, or “target groups,” eligible to be presented with sponsored content. Additional details regarding targeting criteria are described below with reference to FIG. 2.

When sponsored content is eligible for presentation to a user because the user is included in the target group specified by targeting criteria, the online system 100 determines the base value for the target group based at least in part on the amount of revenue the online system 100 may receive from presenting the sponsored content to a target group. In one embodiment, the base value for an individual online system 100 user or target group is proportional to the growth of revenue the online system 100 receives from presenting sponsored content to those users. For example, if a third party system 130 delivers sponsored content to online system 100 users that match targeting criteria, the online system 100 will receive more revenue from the third party system 130 if more of its users are eligible to receive the sponsored content. The online system 100 also determines the base value for the target group based at least in part on one or more objectives associated with the sponsored content. An objective associated with sponsored content specifies a goal for presenting the sponsored content, with the objective satisfied when an interaction corresponding to the objective is completed by the user. Different objectives for presentation of sponsored content are satisfied by different interactions with the sponsored content, so certain objectives are more easily satisfied than others. For example, an objective for a user presented with sponsored content to express a preference for an object associated with the sponsored content is more likely to be satisfied than an objective for a user presented with the sponsored content to provide a post to the object associated with the sponsored content because the objective to express a preference for the object associated with the sponsored content is satisfied when the user performs a simpler or easier interaction that is more likely to be performed by online system 100 users.

Completing objectives associated with sponsored content raises the base value of the target group to which the sponsored content was oriented, in addition to those online system 100 users comprising the target group. Resultantly, the base value held by individual online system 100 users adjusts according to the number of target groups of which an online system 100 user is a member. Being a member of more target groups results in an online system 100 user having a higher base value. Conversely, an online system 100 user that is a member of fewer target groups will have a lower base value. Because the base value associated with online system 100 users and target groups fluctuates over time (e.g., contingent upon targeting criteria as specified by third party systems 130), the online system 100 can observe these fluctuations in order to generate predictions for base values held by users at a later date (e.g., one or more days in the future).

In addition to providing the online system 100 with targeting criteria specifying a target group of online system 100 users, the online system 100 receives from the third party system 130 a timeframe during which a sponsored content is to be presented to the target group. This allows the third party system 130 to specify a period of time to present sponsored content to groups of online system 100 users in which the sponsored content will most likely fulfill its objective. For example, if a sponsored content campaign selects a target group of online system 100 users interested in winter sports, the third party system 130 may elect a timeframe spanning the winter season. In designating a target group through targeting criteria as well as providing a timeframe, the third party system 130 works in tandem with the online system 100 to provide users with sponsored content they might find most relevant during a time period most conducive to the nature of the sponsored content. Additional details regarding the computation of base values and trend values will be describe below.

### II. Online System

FIG. 2 is a block diagram of an online system 100 with a segment trend predictor 260 according to one embodiment. In the embodiment illustrated in FIG. 2, the online system 100 includes a user profile store 200, an action logger 210, an action log 220, a content store 270, a training data store 240, an edge store 250, a web server 280, and segment trend predictor 260. In other embodiments, the online system 100 may include additional, fewer, or different components for various applications. Conventional components such as network interfaces, security functions, load balancers, failover servers, management and network operations consoles, and the like are not shown so as to not obscure the details of the system architecture.

Each user of the online system 100 is associated with a user profile, which is stored in the user profile store 200. A user profile includes declarative information about the user that was explicitly shared by the user and may also include profile information inferred by the online system 100. In one embodiment, a user profile includes multiple data fields, each describing one or more attributes of the corresponding online system user. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with information identifying the online system users displayed in an image, with information identifying the images in which a user is tagged stored in the user profile of the user. A user profile in the user profile store 200 may also maintain references to actions by the corresponding user performed on content items in the content store 270 and stored in the action log 220.

While user profiles in the user profile store 200 are frequently associated with individuals, allowing individuals to interact with each other via the online system 100, user profiles may also be stored for entities such as businesses or organizations. This allows an entity to establish a presence on the online system 100 for connecting and exchanging content with other online system users. The entity may post information about itself, about its products or provide other information to users of the online system 100 using a brand page associated with the entity's user profile. Other users of the online system 100 may connect to the brand page to receive information posted to the brand page or to receive information from the brand page. A user profile associated with the brand page may include information about the entity itself, providing users with background or informational data about the entity.

The content store 270 stores objects that each represent various types of content. Examples of content represented by an object include a page post, a status update, a photograph, a video, a link, a shared content item, a gaming application achievement, a check-in event at a local business, a brand page, or any other type of content. Online system users may create objects stored by the content store 270, such as status updates, photos tagged by users to be associated with other objects in the online system 100, events, groups or applications. In some embodiments, objects are received from third-party applications or third-party applications separate from the online system 100. In one embodiment, objects in the content store 270 represent single pieces of content, or content “items.” Hence, online system users are encouraged to communicate with each other by posting text and content items of various types of media to the online system 100 through various communication channels. This increases the amount of interaction of users with each other and increases the frequency with which users interact within the online system 100.

One or more content items included in the content store 270 include content for presentation to a user and a bid amount. The content is text, image, audio, video, or any other suitable data presented to a user. In various embodiments, the content also specifies a page of content. For example, a content item includes a landing page specifying a network address of a page of content to which a user is directed when the content item is accessed. The bid amount is included in a content item by a user and is used to determine an expected value, such as monetary compensation, provided by an advertiser to the online system 100 if content in the content item is presented to a user, if the content in the content item receives a user interaction when presented, or if any suitable condition is satisfied when content in the content item is presented to a user. For example, the bid amount included in a content item specifies a monetary amount that the online system 100 receives from a user who provided the content item to the online system 100 if content in the content item is displayed. In some embodiments, the expected value to the online system 100 of presenting the content from the content item may be determined by multiplying the bid amount by a probability of the content of the content item being accessed by a user. In one embodiment, such content items are sponsored content items received from the third party system 130.

In various embodiments, a content item includes various components capable of being identified and retrieved by the online system 100. Example components of a content item include: a title, text data, image data, audio data, video data, a landing page, a user associated with the content item, or any other suitable information. The online system 100 may retrieve one or more specific components of a content item for presentation in some embodiments. For example, the online system 100 may identify a title and an image from a content item and provide the title and the image for presentation rather than the content item in its entirety.

Various content items may include an objective identifying an interaction that a user associated with a content item desires other users to perform when presented with content included in the content item. Example objectives include: installing an application associated with a content item, indicating a preference for a content item, sharing a content item with other users, interacting with an object associated with a content item, or performing any other suitable interaction. As content from a content item is presented to online system users, the online system 100 logs interactions between users presented with the content item or with objects associated with the content item. Additionally, the online system 100 receives compensation from a user associated with content item as online system users perform interactions with a content item that satisfy the objective included in the content item.

Additionally, a content item may include one or more targeting criteria specified by the user who provided the content item to the online system 100. These targeting criteria may also be received from the third party system 130 in association with the respective content item. Targeting criteria included in a content item request specify one or more characteristics of users eligible to be presented with the content item. For example, targeting criteria are used to identify users having user profile information, edges, or actions satisfying at least one of the targeting criteria. Hence, targeting criteria allow a user to identify users having specific characteristics, simplifying subsequent distribution of content to different users.

In various embodiments, the content store 270 includes multiple campaigns, which each include one or more content items, such as a sponsored content item. In various embodiments, a campaign in associated with one or more characteristics that are attributed to each content item of the campaign. For example, a bid amount associated with a campaign is associated with each content item of the campaign. Similarly, an objective associated with a campaign is associated with each content item of the campaign. In various embodiments, a user providing content items to the online system 100 provides the online system 100 with various campaigns each including content items having different characteristics (e.g., associated with different content, including different types of content for presentation), and the campaigns are stored in the content store.

In one embodiment, targeting criteria may specify actions or types of connections between a user and another user or object of the online system 100. Targeting criteria may also specify interactions between a user and objects performed external to the online system 100, such as on a third party system 130. For example, targeting criteria identifies users that have taken a particular action, such as sent a message to another user, used an application, joined a group, left a group, joined an event, generated an event description, purchased or reviewed a product or service using an online marketplace, requested information from a third party system 130, installed an application, or performed any other suitable action. Including actions in targeting criteria allows users to further refine users eligible to be presented with content items. As another example, targeting criteria identifies users having a connection to another user or object or having a particular type of connection to another user or object.

The action logger 210 receives communications about user actions internal to and/or external to the online system 100, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with the particular users as well and stored in the action log 220.

The action log 220 may be used by the online system 100 to track user actions on the online system 100, as well as actions on third party systems 130 that communicate information to the online system 100. Users may interact with various objects on the online system 100, and information describing these interactions is stored in the action log 220. Examples of interactions with objects include: commenting on posts, sharing links, checking-in to physical locations via a client device 110, accessing content items, and any other suitable interactions. Additional examples of interactions with objects on the online system 100 that are included in the action log 220 include: commenting on a photo album, communicating with a user, establishing a connection with an object, joining an event, joining a group, creating an event, authorizing an application, using an application, expressing a preference for an object (“liking” the object), and engaging in a transaction. Additionally, the action log 220 may record a user's interactions with advertisements on the online system 100 as well as with other applications operating on the online system 100. In some embodiments, data from the action log 220 is used to infer interests or preferences of a user, augmenting the interests included in the user's user profile and allowing a more complete understanding of user preferences.

The action log 220 may also store user actions taken on a third party system 130, such as an external website, and communicated to the online system 100. For example, an e-commerce website may recognize a user of an online system 100 through a social plug-in enabling the e-commerce website to identify the user of the online system 100. Because users of the online system 100 are uniquely identifiable, e-commerce websites, such as in the preceding example, may communicate information about a user's actions outside of the online system 100 to the online system 100 for association with the user. Hence, the action log 220 may record information about actions users perform on a third party system 130, including webpage viewing histories, advertisements that were engaged, purchases made, and other patterns from shopping and buying. Additionally, actions a user performs via an application associated with a third party system 130 and executing on a client device 110 may be communicated to the action logger 210 by the application for recordation and association with the user in the action log 220.

In one embodiment, the edge store 250 stores information describing connections between users and other objects on the online system 100 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 100, such as expressing interest in a page on the online system 100, sharing a link with other users of the online system 100, and commenting on posts made by other users of the online system 100.

An edge may include various features each representing characteristics of interactions between users, interactions between users and objects, or interactions between objects. For example, features included in an edge describe a rate of interaction between two users, how recently two users have interacted with each other, a rate or an amount of information retrieved by one user about an object, or numbers and types of comments posted by a user about an object. The features may also represent information describing a particular object or user. For example, a feature may represent the level of interest that a user has in a particular topic, the rate at which the user logs into the online system 100, or information describing demographic information about the user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 250 also stores information about edges, such as affinity scores for objects, interests, and other users. Affinity scores, or “affinities,” may be computed by the online system 100 over time to approximate a user's interest in an object or in another user in the online system 100 based on the actions performed by the user. A user's affinity may be computed by the online system 100 over time to approximate the user's interest in an object, in a topic, or in another user in the online system 100 based on actions performed by the user.

Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 250, in one embodiment. Alternatively, each interaction between a user and a specific object is stored as a separate edge. In some embodiments, connections between users may be stored in the user profile store 200, or the user profile store 200 may access the edge store 250 to determine connections between users.

The web server 280 links the online system 100 via the network 120 to the one or more client devices 110, as well as to the one or more third party systems 130. The web server 280 serves web pages, as well as other content, such as JAVA®, FLASH®, XML and so forth. The web server 280 may receive and route messages between the online system 100 and the client device 110, for example, instant messages, queued messages (e.g., email), text messages, short message service (SMS) messages, or messages sent using any other suitable messaging technique. A user may send a request to the web server 280 to upload information (e.g., images or videos) that are stored in the content store 270. Additionally, the web server 280 may provide application programming interface (API) functionality to send data directly to native client device operating systems, such as IOS®, ANDROID™, or BlackberryOS.

### Segment Trend Predictor

The segment trend predictor 260 predicts the total value for a target group of online system 100 users over a future time period. The targeting criteria and timeframe are specified by a third party system 130 associated with a content campaign. By examining trends in total value associated with the target group of online system 100 users, the segment trend predictor 260 captures differences in price trends associated with the target group over an adjustable observation period as determined by the online system 100. The segment trend predictor 260 uses these differences in price trends to forecast future total value for the target group of online system 100 users. This allows the online system 100 to provide third party systems 130 with a forecast for total values belonging to online system 100 users that meet the targeting criteria for sponsored content to be delivered within an upcoming period of time. The segment trend predictor 260 will be discussed in greater detail in the following section.

### III. Exemplary Segment Trend Predictor

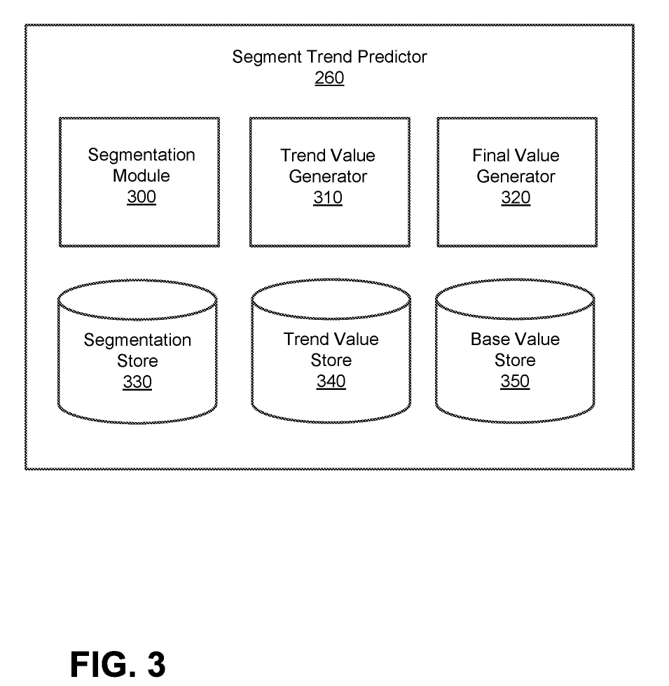

FIG. 3 is a block diagram illustrating an embodiment of a segment trend predictor 260. The segment trend predictor 260 uses information associated with target groups of online system 100 users to generate predictions regarding the total value associated with each group during a specified timeframe within a content campaign. By doing so, the segment trend predictor 260 is able to report trends pertaining to various online system 100 groups. In the embodiment shown in FIG. 3, the segment trend predictor 260 includes a segmentation module 300, a trend value generator 310, a final value generator 320, a segmentation store 330, a trend value store 340, and a base value store 350. The depiction of the segment trend predictor 260 shown in FIG. 3 is for the purpose of illustration; other embodiments of the segment trend predictor 260 may include additional components or exclude one or more of those shown in FIG. 3. Furthermore, the segment trend predictor 260 applies the same, or similar, process to determine the total group value for groups of online system 100 users for purposes other than content campaigns. For example, the segment trend predictor 260 can be used to predict the growth of certain content items (e.g., text, URL, images, videos, and messages) based on number of interactions between the content items and users of the online system 100.

The segmentation module 300 divides the target groups of online system 100 users into a plurality of segments. The segmentation module 300 selects at least one target group having users that match the targeting criteria established by a third party system 130 that has transmitted a message to the online system 100 requesting to provide content to online system 100 users. The segmentation module 300 uses information about each online system 100 user within a target group, or target groups, to divide the target group(s) into a plurality of respective segments. In one embodiment, the segmentation module 300 uses information from the user profile store 200 for each online system 100 user within a target group to identify users that share similar quantifiable characteristics (e.g., age, gender, geolocation, and the like) and places them within the same segment. In another embodiment, online system 100 users that share the same target group are placed into different segments based on activity associated with the online system 100 users within the online system 100. In this embodiment, those users that possess a greater affinity for engagement with objects presented by the online system 100 may be placed within the same segment, whereas those users that are more moderately active, or not active at all, within the online system 100 may be placed in segments of their own. In yet another embodiment, online system 100 users within the same target group are placed into segments based on their respective base values, as assigned by the online system 100, located in the base value store 350. Users sharing base values within a threshold margin from one another are placed into the same segment within the target group, resulting in segments comprised of users that meet approximately the same targeting criteria established by the third party system 130. Information pertaining to the construction of each segment (e.g., the identity of each online system 100 user within a segment, the number of segments comprising the target group, the criteria from which segments were formed, and the like) is stored in the segmentation store 350.

The trend value generator 310 observes base value trends pertaining to a target group of online system 100 users over an adjustable time period, and uses this information to generate a trend value model that can predict future trends (e.g., price trends) for the target group. This trend value model can be trained to predict the projected base value, or “trend value,” of a segment at some future date. For example, if the trend value model is trained to predict the trend value for a given segment seven days ahead of the current day, the trend value generator 310 can provide the trend value model with input values corresponding to the current day. In response, the trend value model can output a predicted trend value seven days ahead based on the input values. The input values used can include the position, the velocity, and/or the acceleration values of the base value of a segment that correspond to the current day.

In some embodiments, the position value can describe the base values that occurred over an adjustable time period for a particular segment of online system 100 users within a target group. For example, a growth curve for a segment may indicate that the segment matched some targeting criteria as specified by 300 third party systems 130 on day 0 and 400 third party systems 130 on day 1. In this example, the base value position value for day 0 is 300 and the position value for day 1 is 400. In some embodiments, the trend value generator 310 computes velocity values for given units of time. For example, the velocity value for a day can be measured based on a change in the base value for a particular segment over some preceding period of time (e.g., the previous 30 days). In some embodiments, the trend value generator 310 can compute acceleration values for given units of time. For example, the acceleration value corresponding to a given day can be measured based on determining a change in the velocity value for that given day (e.g., change in the base value of a particular segment over some preceding period of time). In one example, the trend value model can be trained to account for such values and used to predict a segment's trend value based on the number of instances in which users in the segment matched targeting criteria specified by a plurality of third party systems 130 on a given day (position), the base value over some preceding period of time (velocity), and the change in base value over some preceding period of time (acceleration). Depending on the implementation, one, all, or any combination of the position, velocity, and acceleration values can be used to train the model.

In some embodiments, the trend value generator 310 can generate a design matrix that describes changes in base values for a plurality of online system 100 user segments belonging to a given target group that can be used for training the trend value model. For example, each row in the design matrix can correspond to a specific unit of time (e.g., one day) over some duration of time (e.g., 60 days). In one example, the columns in the design matrix can correspond to an outcome (e.g., the number of instances in which a segment matched targeting criteria of third party systems 130 at a future date), a position value, a velocity value, and an acceleration value. For example, a row describing the base value of a given segment on day 1 can indicate an outcome (e.g., the base value for the segment n days from day 1), the position value determined for day 1, the velocity value determined for day 1, the acceleration value determined for day 1, and which third party systems 130 produced targeting criteria that the segment matched on day 1. In one embodiment, this data allows the model to learn corresponding weights for third party systems 130 and each weight can measure how influential a third party system 130 was to the change in base value for a given segment. For example, a third party system 130 that surpasses a threshold popularity within the online system 100 (as indicated by user interaction with sponsored content associated with the third party system) generates a larger weight contributing to the overall base value of a particular segment than a third party system that did not fulfill the threshold for popularity. This promotes the respective base values of online system 100 users that meet targeting criteria provided by popular third party systems, thus encouraging increased interaction between popular third party systems and online system 100 users.

The third party systems 130 included in the design matrix for purposes of training the trend value model can include all, or some segment of, third party systems 130 from which the online system 100 receives sponsored content. For example, in some embodiments the third party systems 130 included may be restricted to those of a threshold popularity or brand recognition to determine how third party systems 130 of at least this threshold affect base value growth. In other embodiments, the third party systems 130 may be restricted to those that have provided sponsored content that has received a threshold amount of user activity (e.g., click, like, share, etc.) as measured through interactions within the online system 100. The design matrix can be a data structure, such as a two- or three-dimensional matrix.

The training data used to train the trend value model can include a number of training examples. In some embodiments, the training data corresponds to a set of observations for each unit of time (e.g., one day) over some period of time (e.g., 120 days). In such embodiments, each training example can correspond to a particular day within the unit of time and can include an outcome (e.g., the number of matches with targeting criteria for a segment n days away from that particular day), as well as the position value, velocity value, acceleration value, and which third party systems 130 supplied the matching targeting criteria for that particular day. A training example follows:

[Oᵢ,Pₜ,Vₜ,Aₜ,uₜ¹,uₜⁿ] (1)

where 1) Oⱼ corresponds to a number of matches with targeting criteria for a segment on some day j in the future, where 2) Pₜ corresponds to a position value determined for a day t using a growth curve corresponding to the segment, where 3) Vₜ corresponds to a velocity value determined for the day t, where 4) Aₜ corresponds to an acceleration value determined for the day t, where 5) uₜ¹ indicates whether a third party system 1 provided matching targeting criteria on day t, and where 6) uₜⁿ indicates whether a third party system n provided matching targeting criteria on day t. Other features can be included in the training examples depending on the implementation. For example, in some embodiments each training example can include a feature indicating the category associated with the targeting criteria, identification of online system 100 users comprising the segment, information about the target group to which the segment belongs, and the like.

The final value generator 320 uses the trend value associated with each segment of a target group to generate a final value amount that may be used to predict a total value for the entire target group. This final value is influenced by, both, the trend value of each of the plurality of segments comprising a target group and the number of members within each segment. In one embodiment, the final value generator 320 examines the trend value for each segment within a target group from the trend value store 340. In this embodiment, the final value generator 320 uses the number of members in each segment as a multiplier for the trend value associated with each respective segment. In another embodiment, the collective trend values amongst segments of a target group are ranked based on respective trend values during the designated sponsored content campaign timeframe. In this embodiment, the trend value for each segment will be modified by an adjustable, normalized multiplier. The highest trend values receive the highest normalized multipliers; the lowest trend values receive the lowest multiplier.

Other embodiments are contingent upon the means by which the segmentation module 300 divides one or more target groups into a plurality of segments.

### IV. Exemplary Trend Prediction

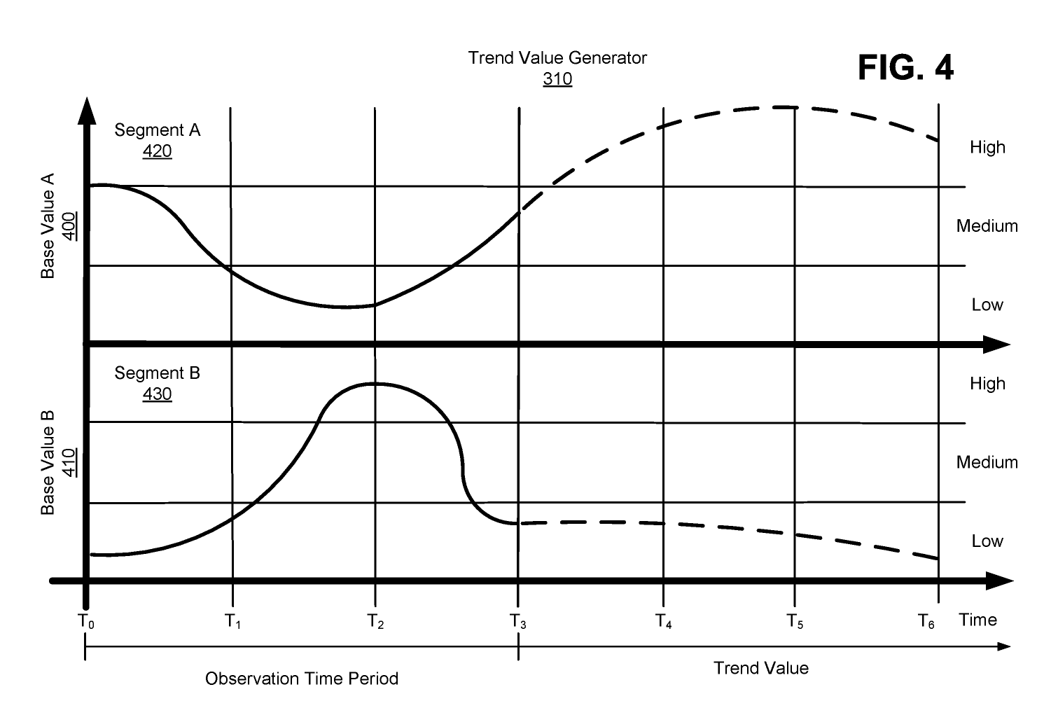

FIG. 4 is a graph illustrating the predicted trend value for segment A 420 and segment B 430. In this example, segment A 420 is comprised of 400 users that are under 30 years old that interact with objects and other users on the online system 100 within an adjustable threshold as established by the online system 100. Segment B 430 is comprised of 500 users over 30 years old that are moderate to not at all interactive within the online system 100 using the same adjustable threshold. Each level of interactivity may be set as a range from a first interaction count to a higher second interaction count.

Both segments belong to a target group that matches the targeting criteria corresponding to the release of a Christmas movie at time T₅, the specified timeframe in which the sponsored content is to be delivered. The initial base value at time T₀ for segment A 420, base value A 400, is high due to the collective medium to high base values of the online system 100 users that comprise segment A 420. Conversely, base value B 410 starts low at T₀ due to the moderate to low engagement employed by the users comprising segment B 430 with the online system 100. Rather than observing the change in base value for the target group as a whole, the trend value generator 310 observes the growth of both segments comprising the target group in order to qualify each trend value component of the final value. The trend value generator 310 selects an observation time period of three months (T₀ to T₃) to observe the changes in base value for both segments in order to predict the trend value at time T₅.

As time progresses, values for both segments change. It can be seen in the figure that at time T₁, the base value for segment A 420 has diminished to a low value as the construct of its members did not meet many targeting criteria between T₀ and T₁. Conversely, the base value for segment B 430 has risen to nearly a medium value at time T₁, indicating that its members, those over 30 years old, were targeted more frequently for sponsored content than the members of segment A 420. At time T₂, the base value for segment A 420 has dropped further, indicating that members of the target group under 30 years old were seldom targeted for sponsored content from time T₁ to T₂. The opposite holds true for segment B 430. At time T₃, the trend value generator 310 reaches the conclusion of the observation time period. The trend value generator 310 uses the position, velocity, and acceleration data collected from time T₀ to T₃ to input into the trend value model that projects the forecasted trend value for both segments at time T₅. The trend value model shows that, despite alternating in nearly a sinusoidal fashion, base value A 400 is higher at time T₅ than it was at the beginning of the observation time period (e.g., at time T₀). In addition, despite undergoing a boost in base value at time T₂, base value B 410 gained little value from time T₀ to time T₅.

### V. Exemplary Prediction Process

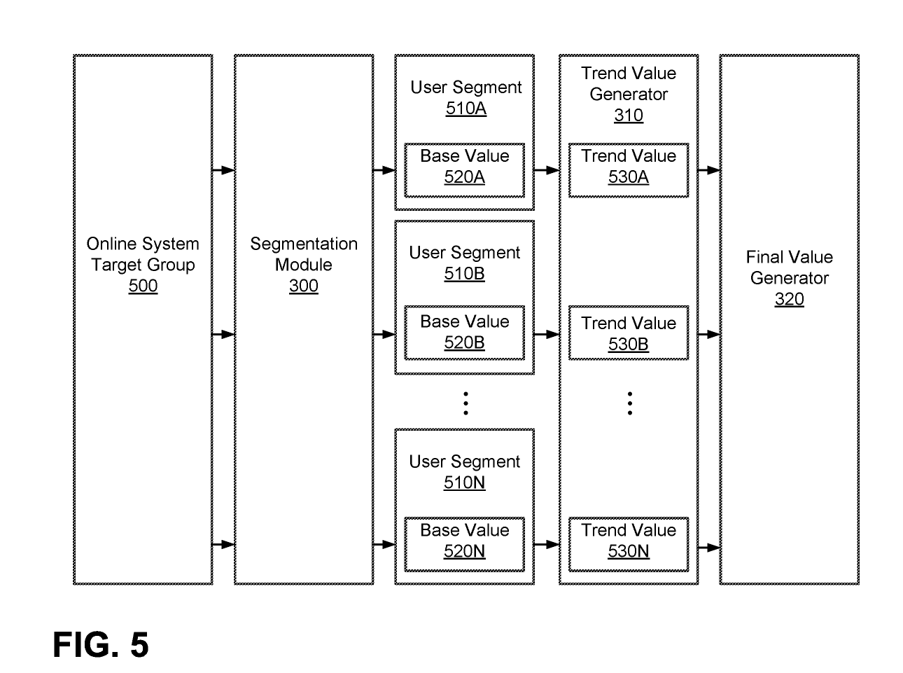

FIG. 5 is a data flow diagram for generating total group value predictions for a target group of online system 100 users. The segmentation module 300 receives as input an online system target group 500 consisting of online system 100 users that have met targeting criteria to receive sponsored content as specified by a third party system 130. The segmentation module 300 divides the target group into individual user segments 510A-N based on demographics (e.g., age, gender, geolocation, etc.) of those online system 100 users that comprise the online system target group 500. Each segment is assigned a base value. In one embodiment, this value is based on a composite (average or otherwise) of the individual base values of each member in the segment. In another embodiment, this value is assigned by the online system 100 to segments based on the extent to which the segment (e.g., the online system 100 users comprising the segment) met the targeting criteria. For example, a segment that met a minimum threshold of targeting criteria and which is included in a target group might receive a lower base value than a segment in the same target group that met a higher threshold of targeting criteria. The base value for each segment is examined by the trend value generator 310 over an observation time period. Observations in growth associated with base values are kept in the trend value store 350 to serve as input into a trend value model generated by the trend value generator 310 and the training data store 240. Trend values are input into the final value generator 320 in addition to information regarding the number of members within each segment to determine the weight held by each segment in generating a final target group value. The final value generator 320 produces a qualitative final value (e.g., high, medium, or low target group final value) associated with a target group of online system 100 users and reports this value to the third party system 130.

### VI. Exemplary Flow

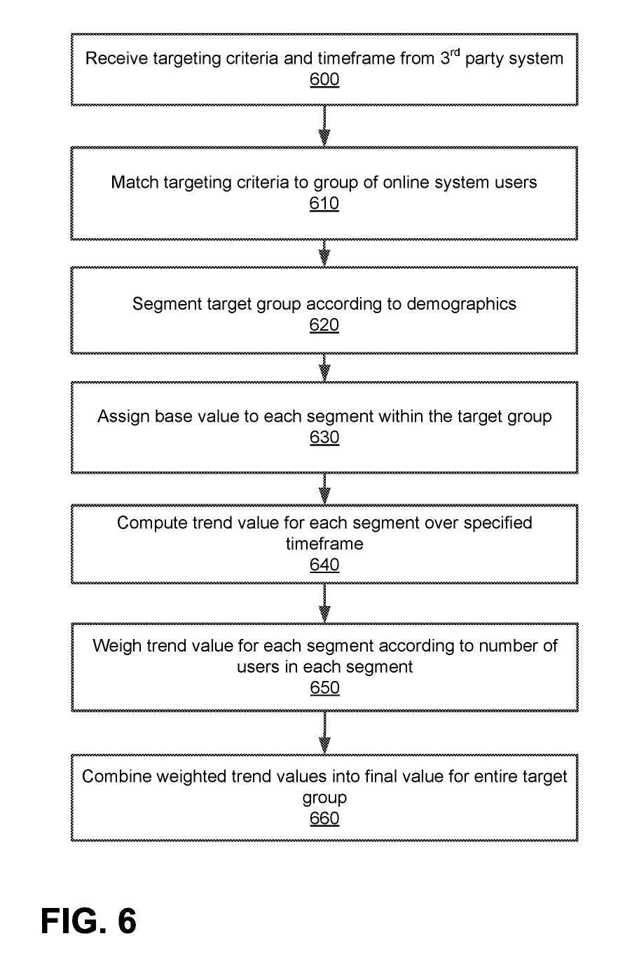

FIG. 6 is a flow chart illustrating a process for capturing differences in price trends for target groups of online system 100 users throughout a specified timeframe. Initially, the online system 100 receives 600 targeting criteria and a timeframe associated with a sponsored content campaign that a third party system 130 wishes to implement. The online system 100 locates a match 610 for the provided targeting criteria within groups of online system 100 users. These target groups are segmented 620 according to demographics (e.g., age, gender, geolocation, etc.) and a base value is assigned 630 to each respective segment. The trend value generator 310 computes 640 the trend value for each segment by observing the fluctuation of each segment's base value over an observation time period. These trend values are assigned weights 650 corresponding to the number of members within each segment, and combined 660 by the final value generator 330 to produce a final value for the entire target group.

### VII. General

The foregoing description of the embodiments of the disclosure has been presented for the purpose of illustration; it is not intended to be exhaustive or to limit the disclosure to the precise forms disclosed. Persons skilled in the relevant art can appreciate that many modifications and variations are possible in light of the above disclosure.

Some portions of this description describe the embodiments of the disclosure in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product including a computer-readable non-transitory medium containing computer program code, which can be executed by a computer processor for performing any or all of the steps, operations, or processes described.

Embodiments of the disclosure may also relate to a product that is produced by a computing process described herein. Such a product may include information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based hereon. Accordingly, the disclosure of the embodiments of the disclosure is intended to be illustrative, but not limiting, of the scope of the disclosure, which is set forth in the following claims.

What is claimed is:

1. A method in an online system comprising:
receiving, at an online system, a plurality of targeting criteria from a third party system for targeting content to users of the online system;
matching at least one of the plurality of targeting criteria to a target group of users of the online system;
generating a plurality of segments of users by dividing the users of the target group into each segment of the plurality of segments;
computing a base value for each segment of the plurality of segments, the base value for each segment being a composite of individual user values of users in each segment;
computing a trend value for each segment of the plurality of segments over an observation time period, the trend value for each segment representing a prediction of base value over time;
computing a weight associated with each segment of the plurality of segments, each weight determined by number of users in each segment;
computing a final value for the target group by combining the trend value of each segment of the plurality of segments according to a respective weight for that segment, the final value representing the entire target group at a future time; and
transmitting the final value to third party system for presentation.

2. The method of claim 1, wherein the plurality of users in each one of the plurality of segments has shared demographics.

3. The method of claim 1, wherein each individual user value for an associated user is computed by:
computing the individual user value based on a number of objectives completed by the associated user.

4. The method of claim 1, wherein each individual user value for an associated user is computed by:
computing individual user value based on compensation received by the online system for the associated user.

5. The method of claim 1, wherein each individual user value for an associated user is computed by:
computing individual user value based on a number of target groups of which the associated user is a member.

6. The method of claim 1, wherein computing the trend value comprises:
accessing a model that can predict trend values for segments of users based on base values of each segment of the plurality of segments, the model trained using training data including base values for segments over a period of time; and
using the model to compute the trend value for each segment of the plurality of segments based on the base value of each segment.

7. The method of claim 1, wherein computing the final value for a target group comprises:
computing a plurality of weights to be applied to the trend values for each of the plurality of segments, the weight determined by the number of users in each of the plurality of segments; and
computing the final value based on a composition of individual trend values associated with the plurality of segments and the plurality of weights.

8. A non-transitory computer readable storage medium having instructions encoded thereon that, when executed by a processor, cause the processor to perform steps including:
receiving, at an online system, a plurality of targeting criteria and a specified timeframe from a third party system;
matching at least one of the plurality of targeting criteria to a target group of users of the online system;
generating a plurality of segments by dividing the users of the target group into each segment of the plurality of segments;
computing a base value for each segment of the plurality of segments, the base value for each segment being a composite of individual user values of users in each segment;
computing a trend value for each segment of the plurality of segments over an observation time period, the trend value for each segment representing a prediction of base value over time;
computing a weight associated with each segment of the plurality of segments, each weight determined by number of users in each segment;
computing a final value for the target group by combining the trend value of each segment of the plurality of segments according to a respective weight for that segment, the final value representing the entire target group at a future time; and
transmitting the final value to third party system for presentation.

9. The non-transitory computer readable storage medium of claim 8, wherein the plurality of segments comprises:
a plurality of users in each of the plurality of segments, wherein the plurality of users in each one of the plurality of segments has shared demographics.

10. The non-transitory computer readable storage medium of claim 8, wherein each individual user value for an associated user is computed by:
computing the individual user value based on a number of objectives completed by the associated user.

11. The non-transitory computer readable storage medium of claim 8, wherein each individual user value for an associated user is computed by:
computing individual user value based on compensation received by the online system for the associated user.

12. The non-transitory computer readable storage medium of claim 8, wherein each individual user value for an associated user is computed by:
computing individual user value based on a number of target groups of which the associated user is a member.

13. The non-transitory computer readable storage medium of claim 8, wherein computing the trend value comprises:
accessing a model that can predict trend values for segments of users based on base values of each segment of the plurality of segments, the model trained using training data including base values for segments over a period of time; and
using the model to compute the trend value for each segment of the plurality of segments based on the base value of each segment.

14. The method of claim 1, wherein computing the final value for a target group comprises:
computing a plurality of weights to be applied to the trend values for each of the plurality of segments, the weight determined by the number of users in each of the plurality of segments; and
computing the final value based on a composition of individual trend values associated with the plurality of segments and the plurality of weights.

15. A method in an online system comprising:
generating a plurality of segments of users of a target group for content of third party system by dividing the users into each segment of the plurality of segments;
computing a base value for each segment of the plurality of segments, the base value for each segment being a composite of individual user values of users in each segment;
computing a trend value for each segment of the plurality of segments over an observation time period, the trend value for each segment representing a prediction of base value over time;
computing a weight associated with each segment of the plurality of segments, each weight determined by number of users in each segment; and
computing a final value for the target group by combining the trend value of each segment of the plurality of segments according to a respective weight for that segment, the final value representing the entire target group at a future time

16. The method of claim 15, wherein each individual user value for an associated user is computed by:
computing the individual user value based on a number of objectives completed by the associated user.

17. The method of claim 15, wherein each individual user value for an associated user is computed by:
computing individual user value based on compensation received by the online system for the associated user.

18. The method of claim 15, wherein each individual user value for an associated user is computed by:
computing individual user value based on a number of target groups of which the associated user is a member.

19. The method of claim 15, wherein computing the trend value comprises:
accessing a model that can predict trend values for segments of users based on base values of each segment of the plurality of segments, the model trained using training data including base values for segments over a period of time; and
using the model to compute the trend value for each segment of the plurality of segments based on the base value of each segment.

20. The method of claim 15, wherein computing the final value for a target group comprises:
computing a plurality of weights to be applied to the trend values for each of the plurality of segments, the weight determined by the number of users in each of the plurality of segments; and
computing the final value based on a composition of individual trend values associated with the plurality of segments and the plurality of weights.
